(19) United States
(12) Patent Application Publication
(10) Pub. No.: US 2026/0057333 A1
(43) Pub. Date: Feb. 26, 2026

(54) MANAGEMENT DEVICE, MANAGEMENT SYSTEM AND MANAGEMENT METHOD

(71) Applicant: HITACHI, LTD., Tokyo (JP)

(72) Inventors: Shinji ISHIHARA, Tokyo (JP); Masaki KANAI, Tokyo (JP)

(21) Appl. No.: 19/283,422

(22) Filed: Jul. 29, 2025

(30) Foreign Application Priority Data
Aug. 22, 2024 (JP) 2024-140918

(51) Int. Cl. G06Q 10/083

(52) U.S. Cl. CPC G06Q 10/083

(57) ABSTRACT

A management device includes a storage place necessary for storage between processes specified among a series of processes leading to shipping of products. The series of processes is divided into small processes based on the specified storage place. A small process behind the storage place in time series is set as a post-process, and a small process ahead of the storage place in time series is set as a pre-process. An input and output required for the post process are calculated based on dealing ability of the post-process, dealing ability of the pre-process and a shipping plan having a target value of a shipping amount and a shipping time. An input and output required for the pre-process are calculated. The storage amount in the storage place disposed between the post-process and the pre-process is calculated based on the calculated input for the post-process and the calculated output for the pre-process.

### CROSS-REFERENCE TO RELATED APPLICATIONS

The present application claims priority under 35 U.S.C. § 119 to Japanese Patent Application No. 2024-140918, filed on Aug. 22, 2024, the contents of which are hereby incorporated by reference in their entirety.

### BACKGROUND OF DISCLOSURE

The present invention relates to a management device, a management system and a management method that manage a system having a plurality of processes.

In a production system or a logistics and conveyance system that is constituted of a plurality of processes, to enable smooth linking between the respective processes, in general, a buffer is provided between the processes in any desired form. Recently, however, “asset light management” that suppresses holding assets to a minimum has been attracting attention. As a result, there arises a demand for reducing the above-mentioned “buffers” as much as possible.

Patent Literature 1 (International Patent Application Publication WO 2020/225995) discloses one technique for reducing the “buffer”. In this literature, there is a description “A process management device includes: an event information management unit that confirms an occurrence of events in a post-process that influences production ability of the post-process that is a process on a downstream side out of two neighboring steps; and a conveyance amount adjustment unit that adjusts distribution of intermediate products prepared in a pre-process for respective operators that is a process on an upstream side out of the two neighboring processes based on personal data of respective operators who perform operations in the post-process indicating production abilities for every occurrence state of the event, and a confirmation result by an event information management unit”.

### SUMMARY OF DISCLOSURE

However, Patent Literature 1 does not disclose a technique to cope with a bottleneck that is not attributed to irregularities of the operators, and hence it is difficult for such a technique to cope with the irregularities in the shipping numbers of products. In this specification, the bottleneck means, for example, a peak season described later by taking a case of a logistic warehouse, a trouble caused by a failure in a machine or the like. It is an object of the present disclosure to properly manage a buffer in a system having a plurality of processes by taking various changes in state into consideration.

A management device according to the present disclosure includes: a specifying unit that specifies a storage place necessary for storage between processes out of a series of processes leading to shipping of a product; a dividing unit that divides the series of processes into a plurality of small processes based on the specified storage place; a setting unit that sets the small process behind the storage place in time series as a post-process and sets the small process ahead of the storage place in time series as a pre-process among the divided small processes; an input processing unit that receives a shipping plan including a target value of a shipping amount and a shipping time of the product; a calculation unit that calculates an input and an output required for the post-process based on dealing ability of the post-process, dealing ability of the pre-process and the shipping plan and, thereafter, calculates an input and an output required for the pre-process, and calculates a storage amount in the storage place disposed between the post-process and the pre-process based on the calculated input required for the post-process and the calculated output required for the pre-process; and an output processing unit that outputs a result calculated by the calculation unit.

Means other than the above-mentioned configuration are described in a mode for carrying out the invention.

### Advantageous Effects of Invention

According to the present disclosure, a buffer of the system that has a plurality of processes can be properly managed by taking various changes of situation into consideration.

### BRIEF DESCRIPTION OF DRAWINGS

FIG. 1 is a view describing a manufacture and conveyance system.

FIG. 2A is a view describing buffers prepared in a plurality of processes.

FIG. 2B is a view describing buffers prepared in a plurality of processes.

FIG. 2C is a view describing buffers prepared in a plurality of processes.

FIG. 3A is a view describing buffers prepared in a plurality of processes.

FIG. 3B is a view describing buffers prepared in a plurality of processes.

FIG. 3C is a view describing buffers prepared in a plurality of processes.

FIG. 4 is a configurational view of a management device.

FIG. 5A is a view describing the combination of a pre-process, a storage place and a post-process.

FIG. 5B is a view describing the combination of a pre-process, a storage place and a post-process.

FIG. 6A is a view describing dynamics of the processes.

FIG. 6B is a view describing dynamics of the processes.

FIG. 6C is a view describing dynamics of the processes.

FIG. 7 is a flowchart of a processing device in a case where dynamics of the respective processes in a single sequence are not changed.

FIG. 8 is a view describing the detail of a process performed by a calculation unit.

FIG. 9A is a view describing a change in dynamics in a process.

FIG. 9B is a view describing a change in dynamics in a process.

FIG. 10 is a view describing a method for changing the dynamics of the process.

FIG. 11A is a view describing power charge system that is an object to be managed by the management device.

FIG. 11B is a view describing power charge system that is an object to be managed by the management device.

FIG. 11C is a view describing power charge system that is an object to be managed by the management device.

FIG. 12 is describing n pieces of sequences arranged in parallel.

FIG. 13 is a view describing the detail of processing performed by the calculation unit by taking into account the ability adjustment of each process.

FIG. 14 is a flowchart of the management device in a case where dynamics of each process changes.

FIG. 15 is a view describing an example where two sequences share a storage place in common.

FIG. 16 is a view describing an example where two sequences share a storage place in common.

FIG. 17 is a view describing the detail of the process performed by the calculation unit to which an inter process surplus management unit is added.

### DESCRIPTION OF EMBODIMENTS

Hereinafter, an embodiment of a management device according to the present disclosure is described with reference to the drawings. The management device treats a system that performs final outputting through a plurality of processes as a management object, manages processing abilities in the respective processes, and decides instructions to the device for controlling outputs the respective processes. It is not always necessary that the management device of the present disclosure is installed on a site of the management object. For example, a result that is obtained by calculation on a cloud can be transmitted to the site.

### First Embodiment

A first embodiment is an example where the management object of the management device 1 is a manufacture and conveyance system that performs the manufacture and the conveyance of products by connecting the inside and the outside of a plant.

### (Configuration of Manufacture and Conveyance System)

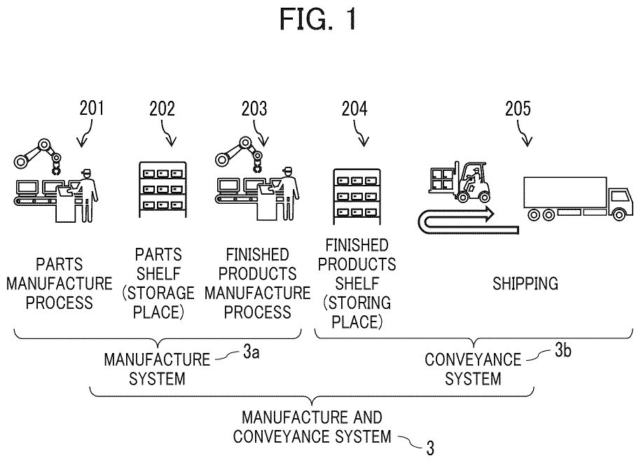

FIG. 1 is a view illustrating a manufacture and conveyance system 3. The manufacture and conveyance system 3 is constituted of a manufacture system 3a and a conveyance system 3b. The manufacture system 3a is constituted of three small processes consisting of: a parts manufacture process 201 where parts are manufactured; parts shelves 202 where the parts are temporarily preserved; and a finished product manufacture process 203 where finished products are manufactured using the parts. The conveyance system 3b is constituted of five small processes consisting of: a finished products shelf 204 where manufactured finished products are temporarily preserved; and a shipping 205 where the finished products are shipped to the outside of the plant. Hereinafter, for the sake of convenience of the description, a series of processing constituted of the plurality of processes may be also referred to as “sequence”.

### (Buffers in Plurality of Processes)

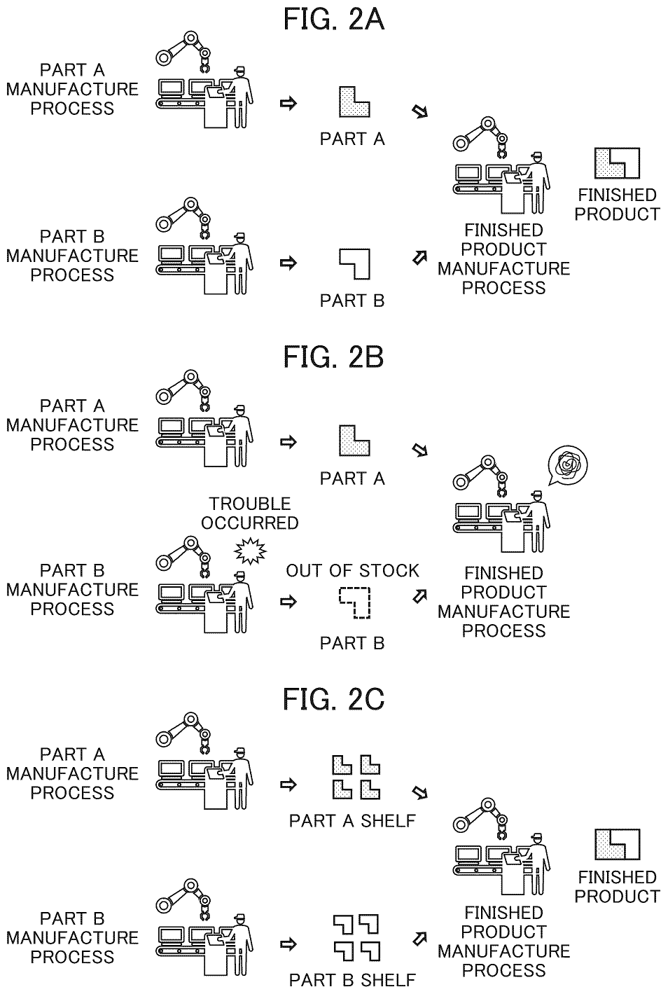

FIG. 2A, FIG. 2B and FIG. 2C are views describing buffers in the plurality of processes. For example, a manufacture system illustrated in FIG. 2A is considered where two parts consisting of a part A and a part B are combined with each other thus manufacturing a finished product. In a finished product manufacture process, to manufacture the finished product, it is necessary to prepare the part A and the part B respectively by one unit. In such a manufacture system, as illustrated in FIG. 2B, when any trouble occurs in the part B manufacture process, the finished product manufacture process cannot obtain the part B and hence, the manufacture is stopped. To avoid such a state, as illustrated in FIG. 2C, after the part A manufacture process and the part B manufacture process and before the finished manufacture process, a shelf is prepared, and parts are prepared on the shelf. Accordingly, even when a trouble occurs in the parts manufacture process, it is possible to continue the manufacture of the finished product. Parts stored in the shelf correspond to “buffer”.

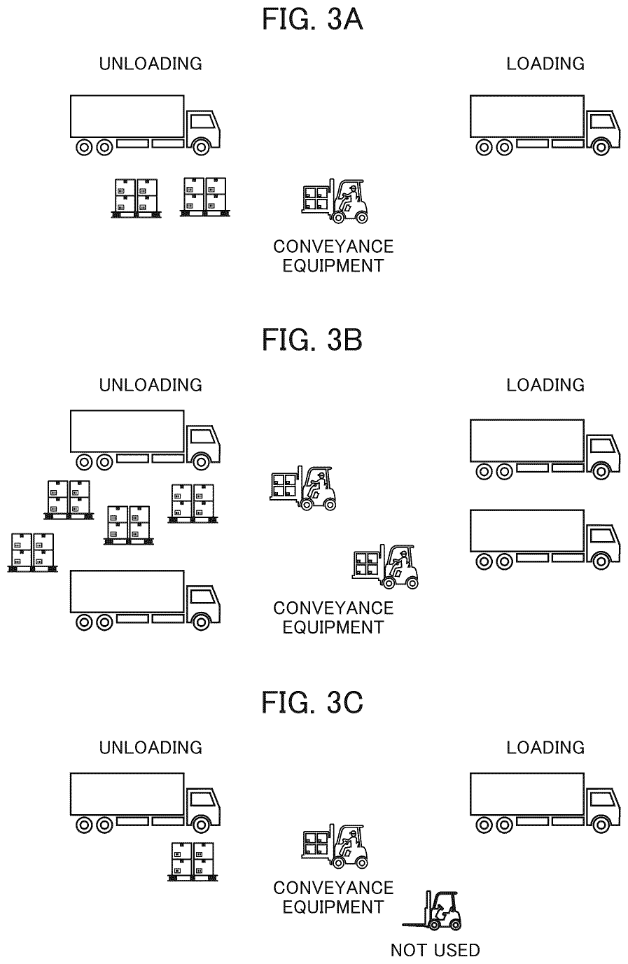

FIG. 3A, FIG. 3B and FIG. 3C are also views describing buffers in a plurality of processes. In a conveyance system illustrated in FIG. 3A, there are processes referred to as loading and unloading. A conveyance equipment such as a forklift is used for performing these processes. In a conveyance system that transports cargos in general, it is necessary to transport a large amount of luggage during a busy season which takes place in a short period such as a summer gift season, or a Christmas season. Accordingly, to transport luggage without stagnation, as illustrated in FIG. 3B, it is necessary to use a plural sets of conveyance equipment. On the other hand, as illustrated in FIG. 3C, in a non-busy season, an amount of luggage is decreased and hence, there is a possibility that it is sufficient to use one set of conveyance equipment. However, in a case where a plant possesses only one conveyance equipment considering a non-busy season, a plant cannot handle a large amount of luggage in a busy season. Accordingly, it is desirable for a plant to possess the number of conveyance equipment by taking into account a busy season. The conveyance equipment that is not used in the non-busy season corresponds to “buffer”.

Although not illustrated in the drawing, in the same manner as described above, as an example of the conveyance system, in an automated logistic warehouse, large amount of conveyance robots ranging from several tens sets to several hundreds sets are used. The number of sets of these robots is decided as the number of sets that correspond to a largest logistic amount or the number of sets that do not cause a trouble in a usual operation even when the trouble occurs in a specific robot and hence, it is hardly conceivable that all robots are used simultaneously. That is, a large number of robots stand by in a non-use state as “buffer”.

The above-mentioned example relates to “buffer” relating to the number of specific objects. However, it is not always the case that “buffer” is limited to an integer value. For example, a buffer tank that is used for stabilizing a pneumatic pressure by replenishing compressed air outputted from an air compressor is one example of “buffer”. Further, a capacitor that is used for efficiently taking a balance between power generated by a generator and power generated by prime mover is also one type of “buffer”. The above-mentioned amount of air and power are not an integer and is a real number.

“buffer” is indispensable to cope with a change of a situation. However, “buffer” does not directly contribute to the creation of an economical value such as manufacture or conveyance. That is, “buffer” is regarded as a surplus preserving asset in usual operation where a trouble has not occurred. Recently, “asset light business” that suppresses preserving assets to a minimum has been attracting attention, and there has been a demand for reducing also “buffer” as much as possible.

### (Configuration of Management Device)

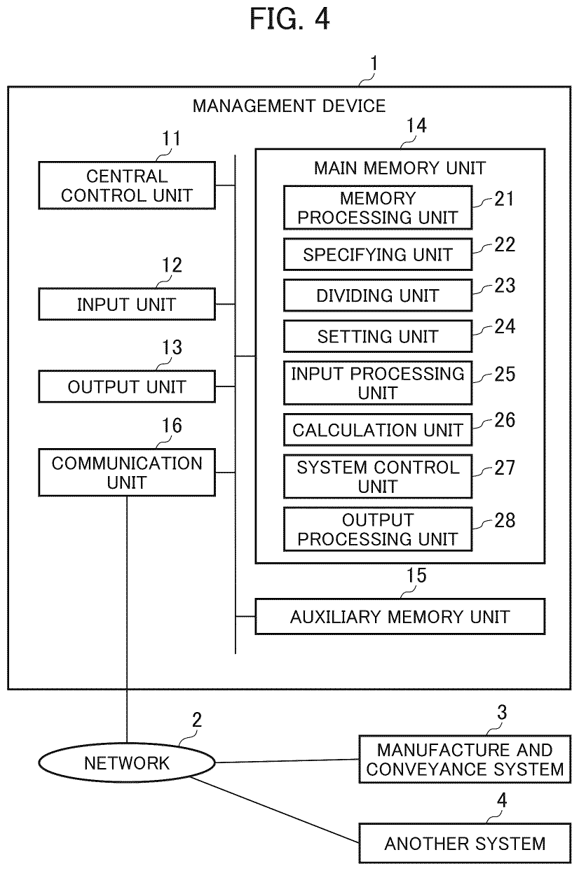

FIG. 4 is a configurational view for the management device 1. The management device 1 is a general-type computer (personal computer, a server or the like). The management device 1 includes a central control unit 11, an input unit 12 such as a mouse or a keyboard, an output unit 13 such as a display, a main memory unit 14, an auxiliary memory unit 15 and a communication unit 16. A memory processing unit 21, a specifying unit 22, a dividing unit 23, a setting unit 24, an input processing unit 25, a calculation unit 26, a system control unit 27 and an output processing unit 28 that are written in the main memory unit 14 are all programs. In the description made hereinafter, in a case where an operation subject is described as “oo unit”, this means that the central control unit 11 reads the respective programs from the auxiliary memory unit 15 to the main memory unit 14 and performs processing described in advance in the respective programs. The management device 1 may be constituted as a single housing as illustrated in FIG. 4, or may be constituted in a divided manner into a plurality of housings.

Besides the management device 1, the manufacture and conveyance system 3 (see FIG. 1) and other systems 4 exist. The manufacture and conveyance system 3 and other systems 4 correspond to “management object system” that are management objects of the management device 1. One example of other systems 4 is a charge system described later. The management device 1 and the management object system constitute the management system. The management device 1 is connected to the manufacture and conveyance system 3 and other systems 4 via a network 2. The management device 1 receives target values and the like relating to these operations from the manufacture and conveyance system 3 and other systems 4. The management device 1 transmits control signals and the like relating to these operations to the manufacture and conveyance system 3 and other systems 4.

The memory processing unit 21 records a series of processes of the manufacture and conveyance system 3 in the auxiliary memory unit 15. “A series of processes” is a concept that includes entire processes that constitute the manufacture and conveyance system 3, and some processes that are continuous with each other out of the entire processes. In this embodiment, a series of processes is constituted of the parts manufacture process 201 through the shipping 205.

The specifying unit 22 specifies a place where a storage is necessary, that is, a storage place out of a series of processes. The specifying unit 22 may automatically specify the storage place, or may receive the indication of the storage place performed by a manager. In this embodiment, the storage place is constituted of the parts shelf 202 and the finished products shelf 204. Further, in a case where a plurality of conveyance equipment are used in the shipping 205 and non-used conveyance equipment exists, the place where the non-used conveyance equipment is preserved is also the storage place.

The dividing unit 23 divides a series of processes into a plurality of small processes based on the storage places specified by the specifying unit 22. In this embodiment, the parts manufacture process 201, the finished product manufacture process 203 and the shipping 205 are already set as small processes by division.

The setting unit 24 defines pre-process and post-process using the storage place as an initiation point. By setting the parts shelf 202 as the storage place, the parts manufacture process 201 ahead of the parts shelf 202 in time series becomes the pre-process, and the finished product manufacture process 203 behind the parts shelf 202 in time series becomes the post-process. Further, using the finished products shelf 204 as the storage place, the finished product manufacture process 203 ahead of the finished products shelf 204 in time series becomes the pre-process, and the shipping 205 behind the finished products shelf 204 in time series becomes the post-process. In this manner, there may be a case where the pre-process at one division becomes the post-process at another division.

The input processing unit 25 receives a shipping plan from the manufacture and conveyance system 3 via the network 2. The shipping plan includes a required target value of a shipping amount of products and a shipping time. The shipping plan is decided by a manager that runs the manufacture and conveyance system 3.

Representative processing of the calculation unit 26 is as follows (detail being described later).

Based on the dealing ability of the post-process, the dealing ability of the pre-process and the shipping plan, the calculation unit 26 calculates an input and an output required for the post-process and, thereafter, calculates an input and an output required for the pre-process. In this specification, “dealing ability” is ability that each process outputs based on an input to each process, and is expressed by a formula 1 described later as a function between the input and the output.

The calculation unit 26 calculates the storage amount at the storage place between the post-process and the pre-process based on the calculated input required for the post-process and the calculated output required for the pre-process.

The system control unit 27 outputs a calculation result of the calculation unit 26 to the manufacture and conveyance system 3. The system control unit 27 may, in more generally speaking, perform an arbitrary control to a unit for each process by outputting various types of signals to the manufacture and conveyance system 3. For example, the adjustment of the numbers of parts manufactured in the parts manufacture process 201 and the adjustment of the number of finished products manufactured in the finished product manufacture process 203 correspond to such a control. Such adjustments can be performed by changing instructions to the control unit of the manufacture and conveyance system 3.

The output processing unit 28 outputs a calculation result of the calculation unit 26 to a graphical user interface (GUI) such as the output unit 13 of the management device 1 or the auxiliary memory unit 15. The output processing unit 28 may output not only a storage amount in the parts shelf 202 and the finished products shelf 204 but also the number of transport equipment not used in the shipping 205.

### (Combination of Pre-Process, Storage Place and Post-Process)

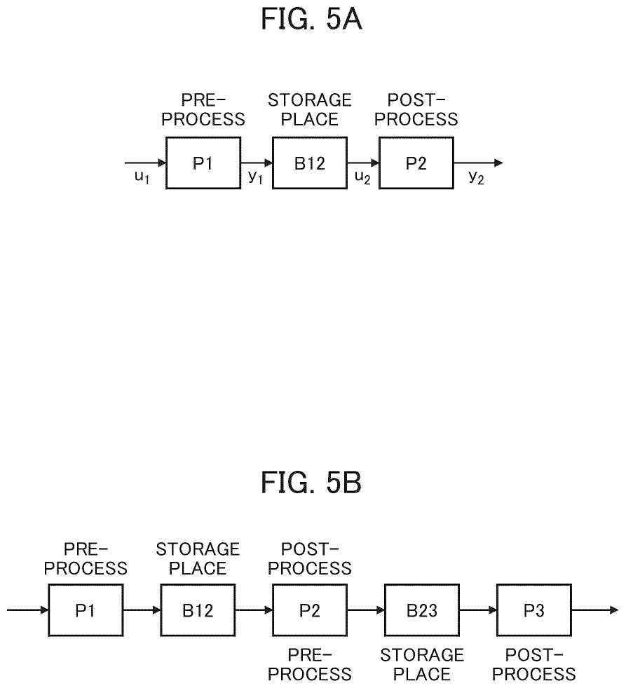

FIG. 5A and FIG. 5B are views describing the combination of the pre-process, the storage place and the post-process. As illustrated in FIG. 5A, one combination of the pre-process, the storage place and the post-process may be expressed as a block diagram where the process (P) is arranged before and after the buffer (B). In a case where there are a plurality of storage places, as illustrated in FIG. 5B, storage places and processes are sequentially added in the rear stage.

### (Processing in Calculation Unit)

Hereinafter, processing that the calculation unit 26 performs is described using the formula 1 to a formula 6. Each process can be expressed as a mathematical model as expressed by the formula 1 where, when an input u is inputted, and output y is outputted. This mathematical model has dynamics, and corresponds to “dealing ability” described above. A subscript i in the formula 1 corresponds to a subscript in the process P. k in the formula 1 means a time (processing step) for every control cycle.

$$\begin{matrix}[ Formula 1 ] & \\ {y}_{i} [ k ] = {f}_{i} ( {u}_{i} [ k - 1 ] ) & ( Formula 1 )\end{matrix}$$

For example, in the case of a manufacture system, dynamics express a time response until a finished product can be manufactured after receiving a manufacture instruction. In the case of the manufacture system, input and output take an integer value (for example, number). In the case of a system that treats processes in a chemical plant, a power generation station and the like, the input and output become real numbers other than integers such as concentration (%), electric power (w) or the like.

The input processing unit 25 receives inputting of a shipping plan via the input unit 12. In this embodiment, the shipping plan includes a target value of a shipping amount (including the number of pieces) of products required during at a point of time of at least N+1 pieces during a point of time k+N elapsed from a point of time k that is a current time. The shipping plan may include shipping amounts of products necessary at respective points of time before and after the period. The target value at the point of time k is given as r [k]. In the calculation made hereinafter, only the target value r from the point of time k to the point of time k+N is focused.

The calculation unit 26 calculates a control input u₂[k] that minimizes an objective function J₂ in a formula 2 such that an output y₂[k] agrees with a target value r [k] as much as possible at each point of time k in the finished product manufacture process P2. Q₂ and R₂ of the formula 2 constitute a weight matrix and are adjustment parameters.

$$\begin{matrix}[ Formula 2 ] & \\ {J}_{2} = {\sum }_{t = k}^{k + N} \{ {( {y}_{2} [ t ] - r [ t ] )}^{T} {Q}_{2} ( {y}_{2} [ t ] - r [ t ] ) + {u}_{2}^{T} [ t ] {R}_{2} {u}_{2} [ t ] \} & ( Formula 2 )\end{matrix}$$

The formula 2 is a formula obtained by formulating a model predictive control (MPC) in general. The calculation unit 26 calculates an input u₂[k] required at each point of time k using MPC. In general MPC, time-series inputs U₂={u₂[k], . . . , u₂[k+N]} that is time-series data of the input u₂[k] is calculated, and only a first step in the time-series, that is, u₂[k] is used. However, the calculation unit 26 in this embodiment effectively uses inputs obtained up to N step. The time-series input U₂ is a result of an optimization calculation and hence, the time-series input U₂ may be also referred to as “optimum control time-series input”. However, for the sake of brevity, the time-series input U₂ is referred to as “time-series input” hereinafter. The same goes for a time-series inputs U₁ described later.

In view of the relationship between the post-process and the pre-process, it is sufficient for the calculation unit 26 to set a minimum value of the number of parts to be stored in the storage place B12 to U₂ or more. To satisfy such a state, an objective function expressed by a formula 3 and a constraint condition expressed by a formula 4 are prepared.

$$\begin{matrix}[ Formula 3 ] & \\ {J}_{1} = {\sum }_{t = k}^{k + N} \{ {( {y}_{1} [ t ] - {{u}^{′}}_{2} [ t ] )}^{T} {Q}_{1} ( {y}_{1} [ t ] - {{u}^{′}}_{2} [ t ] ) + {u}_{1}^{T} [ t ] {R}_{1} {u}_{1} [ t ] \} & ( Formula 3 )\end{matrix}$$

$${{u}^{′}}_{2} [ t ] = {u}_{2} [ t ] + δ {u}_{2} [ t ]$$

The formula 3 means that an output y₁[k] of the pre-process P1 is made to approach to a value obtained by adding a surplus δu₂[k] to an input u₂[k] in the post-process as much as possible.

$$\begin{matrix}[ Formula 4 ] & \\ {y}_{1} [ t ] - {u}_{2} [ t ] \geq δ {u}_{2} [ t ] & ( Formula 4 )\end{matrix}$$

$$δ {u}_{2} [ t ] \geq 0$$

The formula 4 means that the surplus δu₂[k] takes a positive value. This means that at each point of time k, no shortage of an input required for performing the post-process P2 occurs.

MPC can calculate a control input that minimizes an objective function under a constraint condition. Accordingly, the calculation unit 26 can calculate a time-series inputs U₁={u₁[k], . . . , u₁[k+N]} that is time-series data of an input u₁[k] of the pre-process P1 by making use of a frame work of MPC.

As has been described above, the calculation unit 26 can prepare a plan for manufacturing products necessary in a final process while reducing a surplus δu₂ as much as possible by making use of MPC. However, to perform the above-mentioned calculation, it is necessary that a constraint condition in a formula 5 is satisfied for performing the calculation.

$$\begin{matrix}\begin{matrix}[ Formula 5 ] \\ ( Formula 5 )\end{matrix} & \\ {y}_{2 max} \geq r [ t ] & ( 5 a )\end{matrix}$$

$${y}_{1 max} \geq {u}_{2} [ t ] \qquad ( 5 b )$$

$$\vert {y}_{2} [ t + 1 ] - {y}_{2} [ t ] \vert \geq \vert r [ t + 1 ] - r [ t ] \vert \qquad ( 5 c )$$

$$\vert {y}_{1} [ t + 1 ] - {y}_{1} [ t ] \vert \geq \vert {u}_{2} [ t + 1 ] - {u}_{2} [ t ] \vert \qquad ( 5 d )$$

5a in the formula 5 means that a target value r of a product at a point of time k does not exceed a maximum value y₂ₘₐₓ of an output y₂ in the post-process P2.

5b in the formula 5 means that an input u₂ that the post-process requires does not exceed a maximum value y₁ₘₐₓ of an output y₁ of the pre-process P1.

The constraint conditions described in 5a and 5b of the formula 5 relates to a rated output of the manufacture and conveyance system 3. For example, even when the production of 20 pieces per one hour is demanded to the manufacture and conveyance system 3 whose upper limit of production ability per one hour is 10 pieces, the manufacture and conveyance system 3 cannot satisfy such a demand. 5a and 5b of the formula 5 means that such a design that cannot be realized like this can be avoided.

5c in the formula 5 means that a time-series change amount of a target value (r [t+1]−r [t]) does not exceed a time-series change amount of an output in the post-process P2 (y₂ [t+1]−y₂ [t]). 5d in the formula 5 means that a time-series change of an input that the post-process P2 requires (u₂ [t+1]−u₂ [t]) does not exceed a time-series change amount of an output in the pre-process (y₁ [t+1]−y₁ [t]). Constraint conditions in 5c and 5d of the formula 5 relate to dynamics of the manufacture and conveyance system 3.

### (Dynamics)

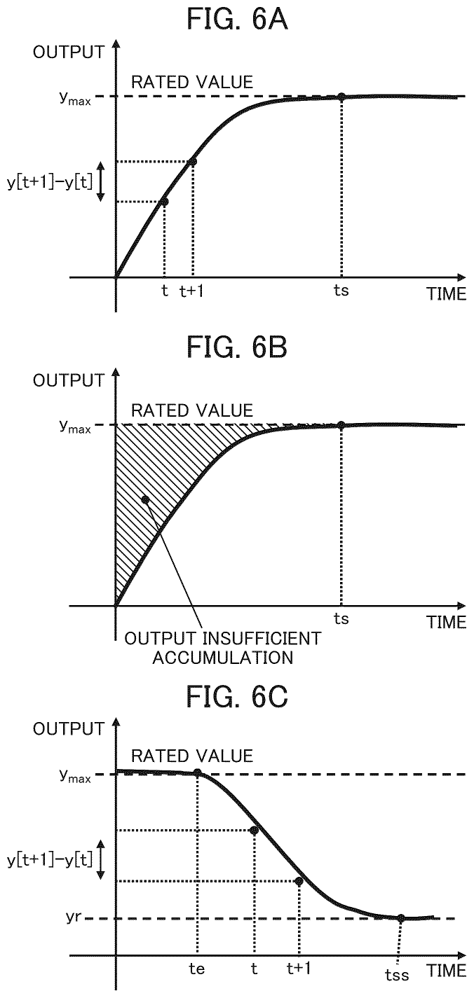

FIG. 6A, FIG. 6B and FIG. 6C are views describing dynamics of processes. Dynamics is a characteristic that an output of each process requires time until the output reaches a rated output yₘₐₓ. As illustrated in FIG. 6A, in general, an output of the manufacture and conveyance system 3 stays at a value equal to or less than a rated output from start (point of time 0) to a point of time ts at which the output reaches the rated output yₘₐₓ. Particularly, in processes necessary for a heat treatment, a chemical reaction and the like, a value of ts is large.

In a case where only a rated output in 5a and 5b of the formula 5 is taken into consideration without taking such dynamics into consideration, a plan that cannot be realized in view of the relationship with the dynamics is calculated and hence, there is a possibility that a cumulative error corresponding to a hatching portion in FIG. 6B is generated. As illustrated in FIG. 6C, also in a case where an output is reduced to a target value yr from a point of time te, an output does not immediately change by being affected by dynamics. Attributed to these phenomena, in 5c and 5d of the formula 5, an absolute value (|⋅|) is used.

In a case where dynamics do not change in each process, the memory processing unit 21 records the dynamics in advance, and the calculation unit 26 uses such dynamics as a constraint condition in the optimization calculation. In a case where the formula 5 is used as the constraint condition, an optimization problem with respect to the post-process P2 is summarized as expressed in the formula 6. The calculation unit 26 calculates U₂ that minimizes J₂ using three formulas below “subject to” as constraint conditions.

$$\begin{matrix}[ Formula 6 ] & \\ {U}_{2} = {min}_{{u}_{2}} {J}_{2} & ( Formula 6 )\end{matrix}$$

$$subject to$$

$${J}_{2} = {\sum }_{t = k}^{k + N} \{ {( {y}_{2} [ t ] - r [ t ] )}^{T} {Q}_{2} ( {y}_{2} [ t ] - r [ t ] ) + {u}_{2}^{T} [ t ] {R}_{2} {u}_{2} [ t ] \}$$

$${y}_{2 max} \geq r [ t ]$$

$$\vert {y}_{2} [ t + 1 ] - {y}_{2} [ t ] \vert \geq \vert r [ t + 1 ] - r [ t ] \vert$$

In the same manner, the optimization problem with respect to the pre-process P1 is summarized as expressed by a formula 7. The calculation unit 26 calculates U₁ that minimizes J₁ using six formulas below “subject to” as constraint conditions.

$$\begin{matrix}[ Formula 7 ] & \\ {U}_{1} = {min}_{{u}_{1}} {J}_{1} & ( Formula 7 )\end{matrix}$$

$$subject to$$

$${J}_{1} = {\sum }_{t = k}^{k + N} \{ {( {y}_{1} [ t ] - {{u}^{′}}_{2} [ t ] )}^{T} {Q}_{1} ( {y}_{1} [ t ] - {{u}^{′}}_{2} [ t ] ) + {u}_{1}^{T} [ t ] {R}_{1} {u}_{1} [ t ] \}$$

$${{u}^{′}}_{2} [ t ] = {u}_{2} [ t ] + δ {u}_{2} [ t ]$$

$${y}_{1} [ t ] - {u}_{2} [ t ] \geq δ {u}_{2} [ t ]$$

$$δ {u}_{2} [ t ] \geq 0$$

$${y}_{1 max} \geq {u}_{2} [ t ]$$

$$\vert {y}_{1} [ t + 1 ] - {y}_{1} [ t ] \vert \geq \vert {u}_{2} [ t + 1 ] - {u}_{2} [ t ] \vert$$

(Flowchart in a Case where Dynamics in Respective Processes do not Change in Single Sequence)

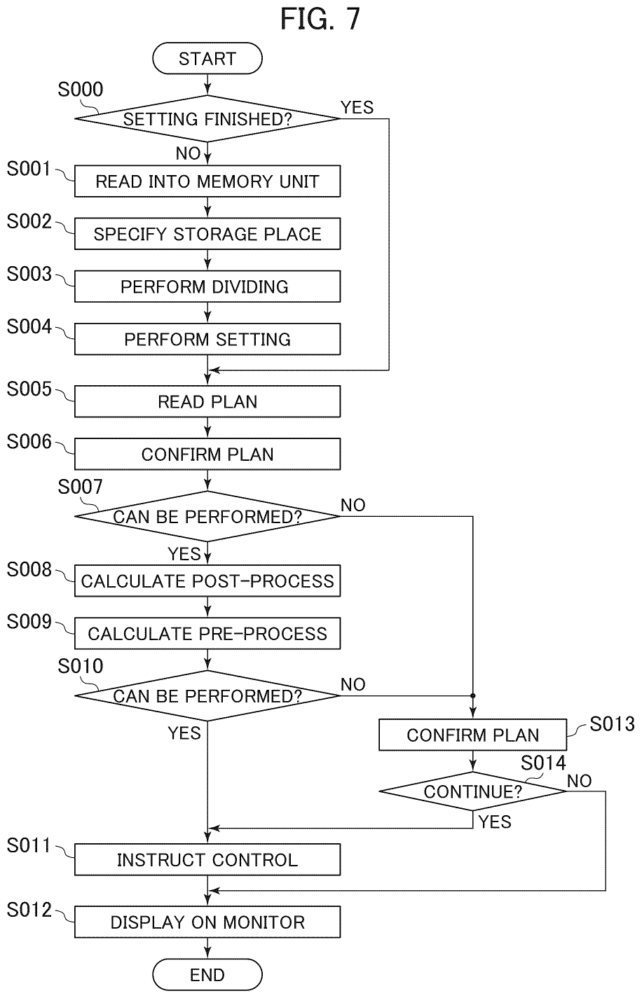

FIG. 7 is a flowchart of the processing device in a case where dynamics of the respective processes do not change in a single sequence. “Step S ooo” in the following description are steps of information processing in the flowchart performed in order, and is a concept different from “processing step” at points of time for every control cycle described above.

In step S000, the input processing unit 25 determines whether or not finishing of the initial setting is inputted via the input unit 12 by a manager. In a case where the initial setting is finished in the input processing unit 25 (YES), the processing advances to step S005, and the processing advances to step S001 in a case where the initial setting is not finished (NO).

In step S001, the memory processing unit 21 reads information or the like relating to a series of processes stored as the content of the initial setting from the auxiliary memory unit 15. The memory processing unit 21 may receive this information from the input unit 12.

In step S002, the specifying unit 22 specifies the storage place based on the information read in step S001.

In step S003, the dividing unit 23 divides a series of steps into small processes based on the storage places specified in step S002.

In step S004, the setting unit 24 sets the pre-process and the post-process using the storage place specified in step S002 as an initiation point, based on dividing processing in step S003.

As has been described above, the processing from step S001 to step S004 is performed repeatedly each time the exchange of the processes of the manufacture and conveyance system 3 is performed. The term “the exchange of the processes” means that the order of a plurality of steps belonging to a certain sequence or merging flow destinations or divided flow destinations change.

In step S005, the input processing unit 25 performs reading of a shipping plan stored in the auxiliary memory unit 15 on a condition that the shipping plan is inputted into the input unit 12. The shipping plan is time-series data. Accordingly, in a case where time-series data from a current time to a far future point of time exist, it is unnecessary for the input processing unit 25 to additionally read the shipping plan.

In step S006, the calculation unit 26 determines whether or not the shipping plan can be performed. To be more specific, the calculation unit 26 determines whether or not a target value r is equal to or less than a rated output y₂ₘₐₓ in the post-process. That is, the calculation unit 26 determines whether or not 5a in the formula 5 is established.

In step S007, the calculation unit 26 divides the processing based on a result of the determination made in step S006. In a case where the shipping plan can be performed, that is, in a case where the target value r is equal to or less than the rated output y₂ₘₐₓ in the post-process (YES), the calculation unit 26 advances the processing to step S008. In a case where a shipping plan cannot be performed, that is, in a case where the target value r is not equal to or less than the rated output y₂ₘₐₓ in the post-process (NO), the calculation unit 26 advances the processing to step S013.

In step S008, the calculation unit 26 calculates a time-series input U₂ that becomes necessary in the post-process in accordance with the formula 2 using the target value r.

In step S009, the calculation unit 26 calculates a time-series input U₁ that becomes necessary in the pre-process in accordance with the formula 3 and the formula 4 using a time-series input U₂ in the post-process calculated in step S008.

In step S010, the calculation unit 26 determines whether or not U₂ and U₁ calculated in step S008 and step S009 can be performed in the post-process and the pre-process respectively. To be more specific, the calculation unit 26 confirms whether or not 5b to 5d in the formula 5 are established. In a case where the post-process and the pre-process can be performed (YES), that is, in a case where 5b to 5d in the formula 5 are established, the calculation unit 26 advances the processing to step S011. On the other hand, in a case where the post-process and the pre-process cannot be performed (NO), the calculation unit 26 advances the processing to step S013.

In the above-mentioned processing, the calculation unit 26 determines the establishment of the restriction condition after minimizing the objective function. However, the calculation unit 26 may minimize the objective function under a restriction condition in accordance with the formula 6 in step S008 and in accordance with the formula 7 in step S009. In this case, the calculation unit 26 does not perform processing via “NO” in step S010.

In step S011, the system control unit 27 outputs a calculation result of the calculation unit 26 to the management object system. That is, the system control unit 27 transmits a time-series input U₁, a time-series input U₂ and a storage amount to the manufacture and conveyance system 3 and the like as control signals.

In step S012, an output processing unit 28 outputs a calculation result of the calculation unit 26 to the output unit 13. That is, the output processing unit 28 displays the time-series input U₁, the time-series input U₂ and the storage amount to a manager.

Step S013 is a processing that is performed in a case where it is determined that the shipping cannot be performed in step S007 or in step S010. Even in the case where shipping cannot be performed, on a condition that a surplus exists in the storage place, outputting can be continued temporarily, or outputting that does not satisfy the plan can be also performed. Accordingly, in step S013, the output processing unit 28 notifies a manager of a result that such a situation brings about, for example, the occurrence of a change in a storage amount in the storage place in advance via the output unit 13.

In step S014, in a case where the input processing unit 25 receives a manipulation that an operation of the manufacture and the conveyance system 3 is continued from the manager (YES), the processing advances to step S011. On the other hand, in a case where the input processing unit 25 receives a manipulation that the operation of the manufacture and the conveyance system 3 is not continued (NO), the processing advances to step S012.

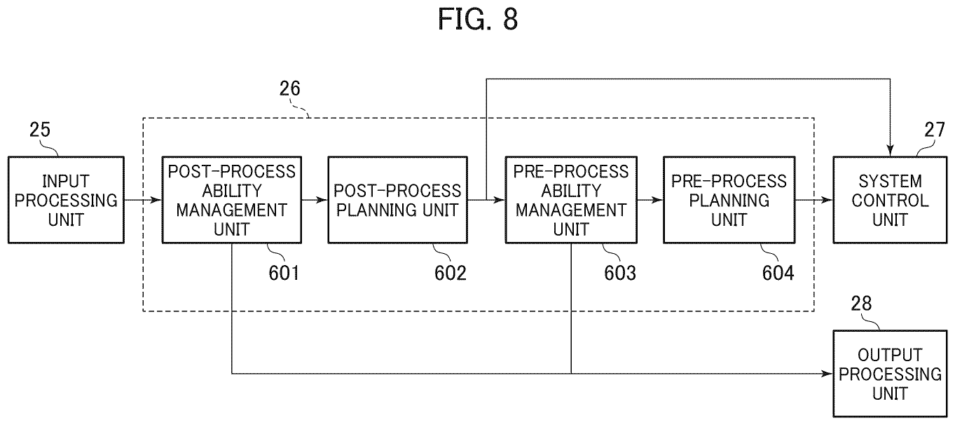

FIG. 8 is a flowchart illustrating the detail of the processing performed by the calculation unit 26. The calculation unit 26 is constituted of: a post-process ability management unit 601; a post-process planning unit 602; a pre-process ability management unit 603; and a pre-process planning unit 604.

The post-process ability management unit 601 calculates a time-series target value R={r[k], r[k+1], . . . , r[k+N]} that are scheduled to be outputted in the post-process ranging from a current time k to an N step, based on a time-series target value r obtained from the input processing unit 25. The post-process ability management unit 601 determines whether or not a maximum output in the post-process is equal to or more than a target value by comparing this time-series target value R with a maximum value y₂ₘₐₓ of an output in the post-process P2. Further, the post-process ability management unit 601 determines whether or not ability of the post-process that deals with a time-series change of an output is equal to or more than a time-series change of a target value by determining whether or not 5c in the formula 5 is established. In a case where the maximum output in the post-process is not equal to or more than the target value or in a case where ability of the post-process that deals with a time-series change of an output is not equal to or more than the time-series change of the target value, the post-process ability management unit 601 notifies the output processing unit 28 of such a state. The output processing unit 28 displays such a state to a manager via the output unit 13. In this processing, R is irrelevant to right sides R₁ and R₂ (weight matrixes) in the formula 2 and the formula 3.

The post-process planning unit 602 plans a time-series input U₂ of the post-process with respect to the time-series target value R. In this case, the post-process planning unit 602 plans, as U₂, at least either one of an amount of input and a point of time of inputting. Further, the post-process planning unit 602 transmits a first step u₂[k] out of the planned time-series input U₂ to the system control unit 27.

The pre-process ability management unit 603 determines whether or not the maximum output of the pre-process is equal to or more than an input that the post-process planning unit has planned by comparing a time-series input U₂ that the post-process planning unit 602 planned with a maximum value y₁ₘₐₓ of an output of the pre-process P1. Further, the pre-process ability management unit 603 determines whether or not ability of the pre-process that deals with a time-series change of an output is equal to or more than a time-series change of the input that the post-process planning unit 602 has planned by determining whether or not 5d in the formula 5 is established. In a case where a maximum output in the pre-process is not equal to or more than an input that the post-process planning unit 602 has planned or in a case where ability of the pre-process that deals with a time-series change of an output is not equal to or more than a time-series change of an input that the post-process planning unit 602 has planned, the pre-process ability management unit 603 notifies the output processing unit 28 that a change occurs in a storage quantity at the storage place attributed to the above-mentioned phenomenon. The output processing unit 28 displays such a state to a manager via the output unit 13.

The pre-process planning unit 604 plans a time-series input U₁ of the pre-process. In this case, the pre-process planning unit 604 plans at least either one of an amount of an input and a point of time of inputting as U₁. Further, the pre-process planning unit 604 transmits the first step u₁[k] out of the planned time-series U₁ to the system control unit 27.

Heretofore, the description has been made on the premise that the sequence is one and the dynamics of each process does not change. However, the present disclosure is also applied to a situation where two sequences exist in parallel (two (a plurality of) sequences existing in parallel) so that dynamics in the process changes. Particularly, in a case where dynamics of the process can be changed in accordance with an intention of a manager, the optimization of the dynamics of the process can be realized by changing the order of an arithmetic operation performed by the above-mentioned calculation unit 26.

### Example 1 of Change of Dynamics

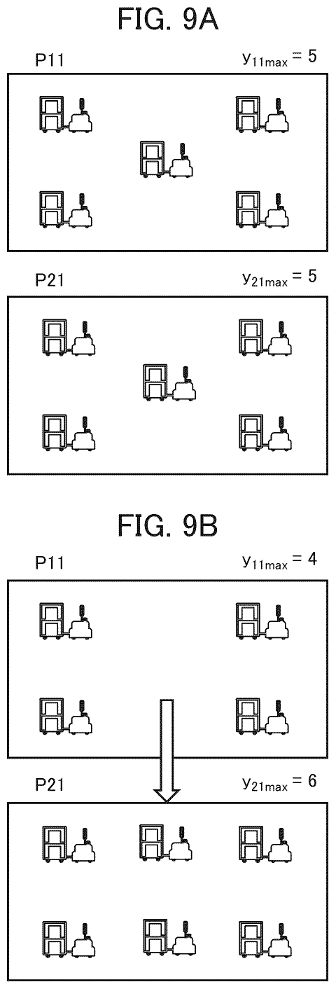

FIG. 9A and FIG. 9B are views describing a change in dynamics of processes. As an example that can change the dynamics of the process, in the manufacture and conveyance system 3 illustrated in FIG. 1, the conveyance process ranging from the parts manufacture process 201 to the parts shelf 202 is considered. As illustrated in FIG. 9A, two parts manufacture lines exist, and the conveyance process is prepared for each parts manufacture line. Assume the respective processes as P11 and P12. The conveyance equipment used in the conveyance process is the same kind of robot.

In the situation illustrated in FIG. 9A, both the process P11 and the process P21 use 5 sets of robots respectively and hence, y₁₁ₘₐₓ and y₂₁ₘₐₓ that are conveyance abilities (=rated outputs) are “5”. The working places of the robot having the same standard can be easily changed. Accordingly, in this case, as illustrated in FIG. 9B, one robot is moved from the process P11 to the process P21. As a result, y₁₁ₘₐₓ that is conveyance ability is changed to “4”, and y₂₁ₘₐₓ that is a conveyance ability is changed to “6”. In this manner, by dynamically adjusting the number of robots to be used, abilities can be changed corresponding to the increase or decrease of production plans of the respective parts manufacture lines.

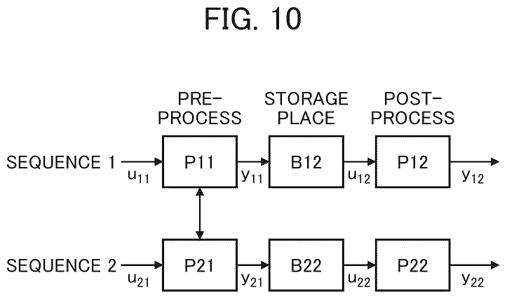

FIG. 10 is a view describing a method of changing dynamics of the processes. In FIG. 10, two sequences exist in parallel (parallel sequence). The sequence 1 that constitutes the parallel sequence uses the conveyance systems on upper stages of FIG. 9A and FIG. 9B. On the other hand, the sequence 2 that constitutes parallel sequence uses the conveyance systems on lower stages of FIG. 9A and FIG. 9B. In the sequence 1, the pre-process is P11 and the post-process is P12. In the sequence 2, the pre-process is P21 and the post-process is P22. On the premise that the robot moves between pre-processes of two sequences, bi-directional arrows are drawn between the pre-process P11 and the pre-process P21.

To perform an optimum distribution plan of the conveyance robots, first, the calculation unit 26 calculates the time-series inputs U₁₁ and U₂₁ with respect to the pre-process P11 and the pre-process P21 without taking the formula 5 into consideration explicitly. Then, the calculation unit 26 calculates an output time-series Y₁₁ and Y₂₁ obtained by applying the obtained time-series inputs Un and U₂₁ in the forward direction. The calculation unit 26 adjusts the number of robots such that the output time-series Y₁₁ and Y₂₁ obtained as described above does not exceed the conveyance abilities y₁₁ₘₐₓ and y₂₁ₘₐₓ. A total value of y₁₁ₘₐₓ and y₂₁ₘₐₓ is a fixed constant. Accordingly, a calculation result that exceeds the total value is not allowed. The term “without taking the formula 5 into consideration explicitly” means that even the optimization that does not use the formula 5 as a restriction condition can expect a result to some extent (meaning that the formula 5 is an option).

The above-mentioned example allows the exchange of the number of conveyance robots so that a rated output yₘₐₓ can be changed. However, dynamics cannot be largely changed. On the other hand, the present disclosure is used also in the ability adjustment in the process where dynamics can be largely changed.

### Example 2 of Change of Dynamics: Second Embodiment/Charge System

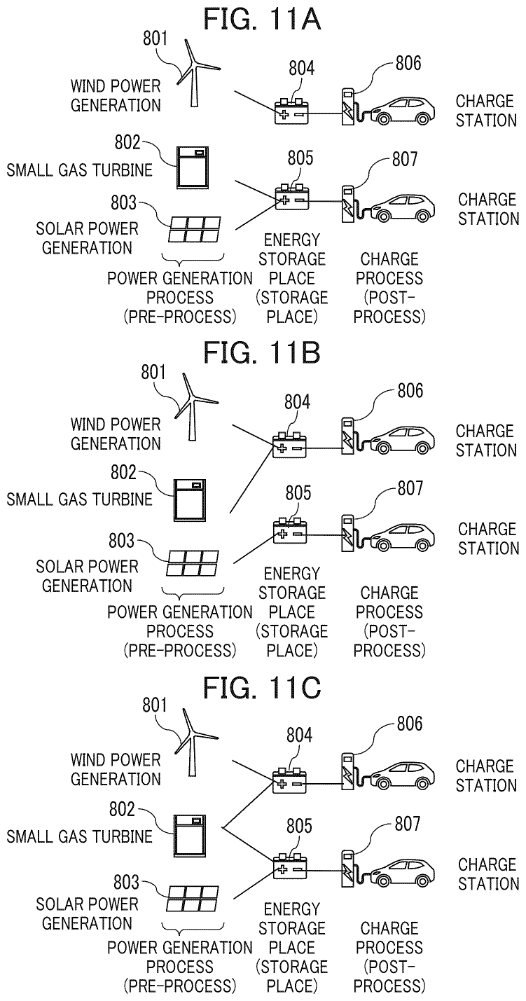

FIG. 11A, FIG. 11B and FIG. 11C are views describing a charge system as a management target of the management device 1. FIG. 11A is a charge system for an electric vehicle (EV). The charge system stores power generated by a wind power generation 801, a small-sized gas turbine 802 and a solar power generation 803 in capacitors 804 and 805. Alternatively, power is directly transmitted to charge stations 806 and 807, and charges the EVs. In the charge system, the capacitor is regarded as a storage place, a power generation process can be regarded as a pre-process, and a charge process to the EV can be regarded as a post-process. In general, the capacitor is degraded due to the repetition of charging and discharging and hence, it is desirable to transmit power to the charge station without via the capacitor as much as possible. This demand is similar to the demand of reducing a shelf inventory as much as possible in the above-mentioned manufacture and conveyance system 3.

A power generation amount of the wind power generation 801 and a power generation amount of the solar power generation 803 largely fluctuate depending on weather. Accordingly, to compensate a shortage of a power generation amount, the small-sized gas turbine 802 is used. In FIG. 11A, although wind volume is sufficient, sunshine is insufficient, and the small-sized gas turbine 802 is connected to the capacitor 805 and the charge station 807.

On the other hand, in FIG. 11B, although sunshine is sufficient, wind volume is insufficient, and the small-sized gas turbine 802 is connected to the capacitor 804 and the charge station 806. Corresponding to such a change in a state, it is necessary to suitably change a power generation amount of the small-sized gas turbine 802. However, a power generation amount of the small-sized gas turbine 802 changes corresponding to a change of a turbine rotational speed due to gas combustion. Accordingly, the change in the power generation amount has dynamics illustrated in FIG. 6A. Accordingly, it is necessary to adopt an ability adjustment method that takes dynamics of the small-sized gas turbine 802 into consideration. As illustrated in FIG. 11C, power that the small-sized gas turbine 802 generates may assist both the wind power generation 801 and the solar power generation 803.

FIG. 10 also corresponds to an example of the charging system. The sequence 1 mainly uses the wind power generation. The sequence 2 mainly uses the solar power generation. On the premise that the connection destination of the small-sized gas turbine 802 changes and hence, bi-directional arrows are drawn between the pre-process P11 and the pre-process P21.

An operation method of the charging system to which the present disclosure is applied is described. First, the calculation unit 26 calculates, together with sequences 1 and 2, time-series inputs U₁₂ and U₂₂ with respect to the post-process P12 and the post-process P22 without taking the formula 5 into consideration explicitly. Further, the calculation unit 26, using these time-series inputs U₁₂ and U₂₂, calculates the time-series inputs U₁₁, U₂₁ without taking the formula 5 into consideration explicitly with respect to the pre-process P11 and the pre-process P21. The calculation unit 26 can calculate the respective output time-series Y₁₁ to Y₂₂ by solving the obtained control inputs U₁₁ to U₂₂ of the pre-process and the post process in a forward direction. The calculation unit 26 adjusts the connection destination of the small-sized gas turbine such that the output time-series obtained here satisfies the restriction relating to a rated output corresponding to 5b in the formula 5 and the restriction relating to dynamic power generation ability corresponding to 5d in the formula 5.

The above-mentioned description is made with respect to the exchange of the pre-processes P11 and P21. However, the same goes for the post-process. Further, although the pre-process and the post-process are included in two sequences (that is, both two sequences exist in the storage place) in the description made above, the scope that the present disclosure is applicable is not limited to such a case.

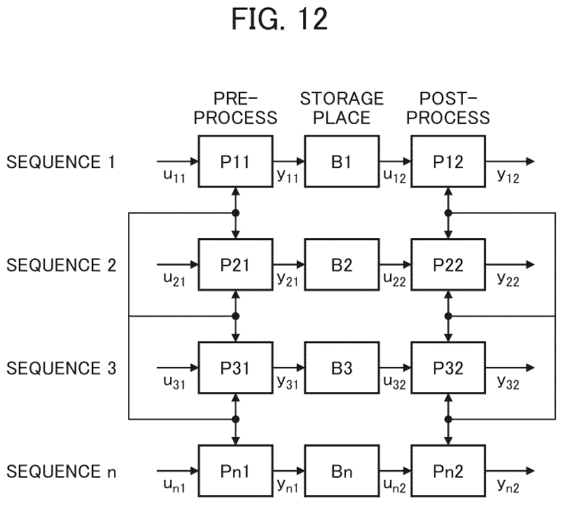

FIG. 12 is a view illustrating n pieces of sequences arranged in parallel. As illustrated in FIG. 12, the management target system may be a system where n pieces (n being an integer) of sequences are performed in parallel.

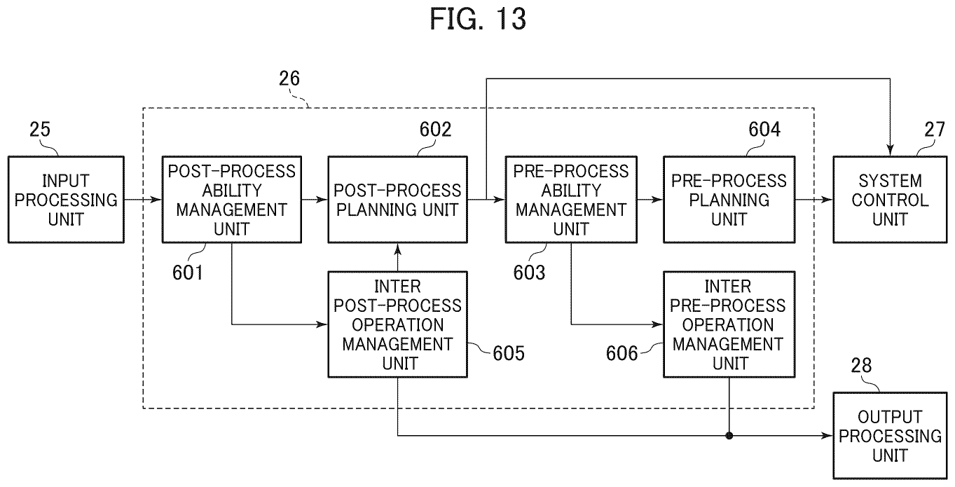

FIG. 13 is a block diagram illustrating the detail of processing performed by the calculation unit 26 while taking ability adjustments of the respective processes into consideration. The calculation unit 26 illustrated in FIG. 13 includes, a post-process ability management unit 601, a post-process planning unit 602, a pre-process ability management unit 603, a pre-process planning unit 604, an inter post-process operation management unit 605, and an inter pre-process operation management unit 606.

Based on a time-series target value rᵢ that is obtained from the input processing unit 25, the post-process ability management unit 601 calculates time-series target values Rᵢ={rᵢ[k], rᵢ[k+1], . . . , rᵢ[k+n]} to be outputted in the post-process from a current time k up to an N step. In the above expression, a subscript i=1 . . . n are numbers that correspond to the processes. Further, in the post-process ability management unit 601 determines whether or not abilities of the respective post-processes P12, P22, . . . . Pn2) are sufficient with respect to the time-series target value Rᵢ in the same manner as described above. The post-process ability management unit 601 performs, besides the above, the processing described with reference to FIG. 8. Here, Rᵢ is irrelevant to R₁ and R₂ (weigh matrixes) on right sides of the formula 2 and the formula 3.

The inter post-process operation management unit 605 performs each inter post-process ability interchange between the different sequences such that a target value rᵢ can be realized by adjusting surplus and shortage of ability of each post-process with respect to a target value rᵢ that the post-process ability management unit 601 determines. To be more specific, in a case where the post-process ability management unit 601 determines that a maximum output in the post-process in a specific sequence is not equal to or more than a target value or ability of the post process that deals with a time-series change of an output is not equal to or more than a time-series change of the target value in the specific sequence, the inter post-process operation management unit 605 decides to provide at least a portion of ability of the post-process in another sequence to the post-process in the specified sequence. That is, the inter post-process operation management unit 605 provides a portion of ability of the post-process where ability is in surplus in another sequence (r<y₂ₘₐₓ) to the post-process where ability is insufficient in the specified sequence (r>y₂ₘₐₓ). In a case where the targe value rᵢ cannot be realized even when any ability interchange is performed, the inter post-process operation management unit 605 notifies the output processing unit 28 of a state. The output processing unit 28 displays such a state to a manager via the output unit 13.

The post-process planning unit 602 plans a time-series input U₂ of the post-process based on an output result of the post-process ability management unit 601 and an output result of the inter post-process operation management unit 605. Further, the post-process planning unit 602 transmits a first step uᵢ₂[k] out of the calculated time-series Uᵢ₂ to the system control unit 27.

The pre-process ability management unit 603 determines whether or not abilities of the respective pre-processes (P11, P21, . . . , Pn1) are sufficient with respect to a time-series input U₂ that the post-process planning unit 602 plans. The pre-process ability management unit 603, besides the above, also performs processing described with reference to FIG. 8.

The inter pre-process operation management unit 606 performs each inter pre-process ability interchange between the different sequences such that a time-series input U₂ can be realized by adjusting a surplus or shortage of ability of each pre-process with respect to time-series input U₂ that the pre-process ability management unit 603 determines. To be more specific, in a case where the pre-process ability management unit 603 determines that a maximum output in the pre-process in the specified sequence is not equal to or more than an input that the post-process planning unit 602 plans, or, in a case where the pre-process ability management unit 603 determines that ability of the pre-process that deals with a time-series change of an output in the specified sequence is not equal to or more than a time-series change of an input that the post-process planning unit 602 plans, the inter pre-process operation management unit 606 decides to provide at least a portion of ability of the pre-process in another sequence to the pre-process in the specified sequence. That is, the inter pre-process operation management unit 606 provides a portion of ability of the pre-process where ability is in surplus (u₂<y₁ₘₐₓ) in another sequence to the pre-process where ability is insufficient (u₂>y₁ₘₐₓ) in the specified sequence. In a case where the time-series input U₂ cannot be realized even when any ability interchange is performed, the inter pre-process operation management unit 606 notifies the output processing unit 28 of a state. The output processing unit 28 displays such a state to a manager via the output unit 13.

The pre-process planning unit 604 plans the time-series input U₁ of the pre-process based on an output result of the pre-process ability management unit 603 and an output result of the inter pre-process operation management unit 606. Further, the pre-process planning unit 604 transmits a first step uᵢ₁[k] out of the calculated time-series input Uᵢ₁ to the system control unit 27.

(Flowchart in a Case where Dynamics of Respective Steps Change)

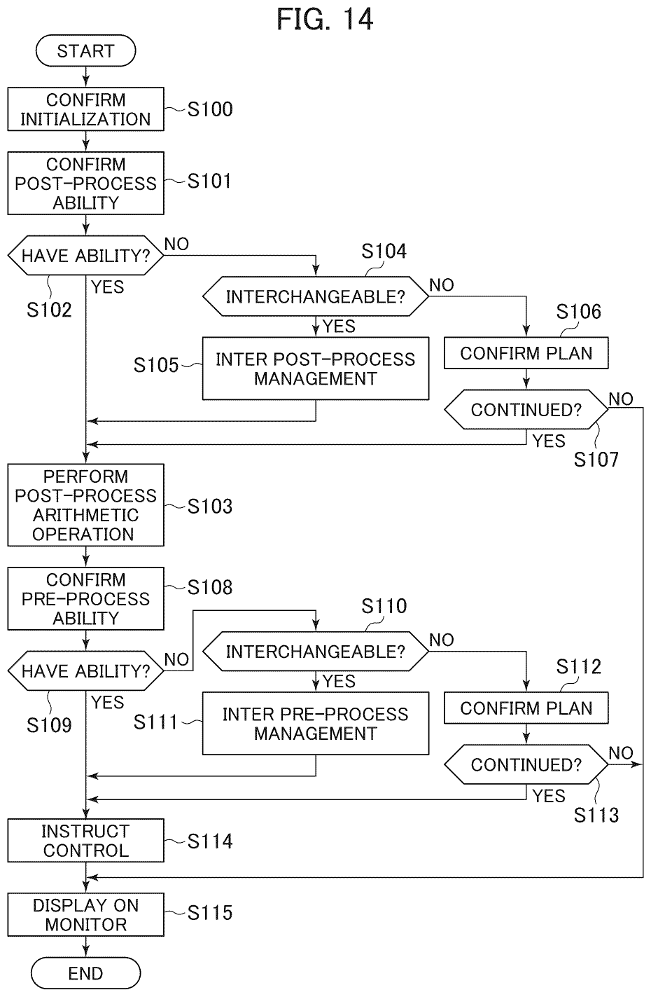

FIG. 14 is a flowchart of the management device when dynamics of respective steps change. The flowchart illustrated in FIG. 14 has large number of parts similar to the corresponding parts in the flowchart illustrated in FIG. 7 and hence, only points that make the flowchart illustrated in FIG. 14 differ from the flowchart illustrated in FIG. 7 are described.

An initial confirmation in step S100 corresponds to processing ranging from step S000 to step S005.

In step S101, the post-process ability management unit 601 determines whether or not the respective post-processes have ability to perform the time-series target value Rᵢ.

In step S102, the post-process ability management unit 601 divides processing based on a result obtained by the determination made in the step S101. In a case where the respective post-processes have ability to perform the time-series target value Rᵢ (YES), the post-process ability management unit 601 advances the processing to step S103. In a case where the respective post-processes do not have ability (NO), the post-process ability management unit 601 advances the processing to step S104.

In step S103, the post-process planning unit 602 makes an operation plan of the post-processes. This processing is performed in the same manner as the step S008.

In step S104, the inter post-process operation management unit 605 determines whether or not processing of respective post-processes can be continued by performing an ability interchange. At this stage of processing, the inter post-process operation management unit 605, as described above, determines whether or not an ability interchange can be performed between different sequences such that a part of ability of the post-process where ability is in surplus can be shared as ability of another post-process where ability is insufficient. In the case where the processing in the respective post-processes can be continued by performing an ability interchange (YES), the inter post-process operation management unit 605 advances processing to step S105. On the other hand, in a case where the processing cannot be continued in all post-processes even when an ability interchange is performed (NO), the inter post-process operation management unit 605 advances processing to step S106.

In step S105, the inter post-process operation management unit 605 decides to provide ability of the post-process Pj2 where ability is in surplus to the post-process Pi2 where ability is insufficient.

Processing in step S106 and processing in step S107 are equal to processing in step S013 and processing in step S014.

In step S108, the pre-process ability management unit 603 determines whether or not the pre-processes have ability to perform time-series input Uᵢ₂ in the post-processes calculated in step S103.

Hereinafter, processing from step S109 to step S113 is equal to processing in step S102 and in step S104 to step S107 relating to the post processing processes and hence, the description of the processing is omitted. In this case, in steps S109, S110 and S111, “post-oo unit” in steps S102, S104, and S105 is exchanged by “pre-oo unit”, and “post-process Pi2” and “post-process Pj2” in steps S102, S104, and S105 are respectively exchanged by “pre-process Pi1” and “pre-process Pj1”.

The processing in step S114 and step S115 is equal to processing in step S011 and step S012.

### (Sharing of Storage Place)

In the description made heretofore, the example is described where in each sequence, between the pre-process and the post-process, one storage place dedicated to each sequence is provided. However, the present disclosure is not limited to such a mode, and a plurality of sequences share the storage place.

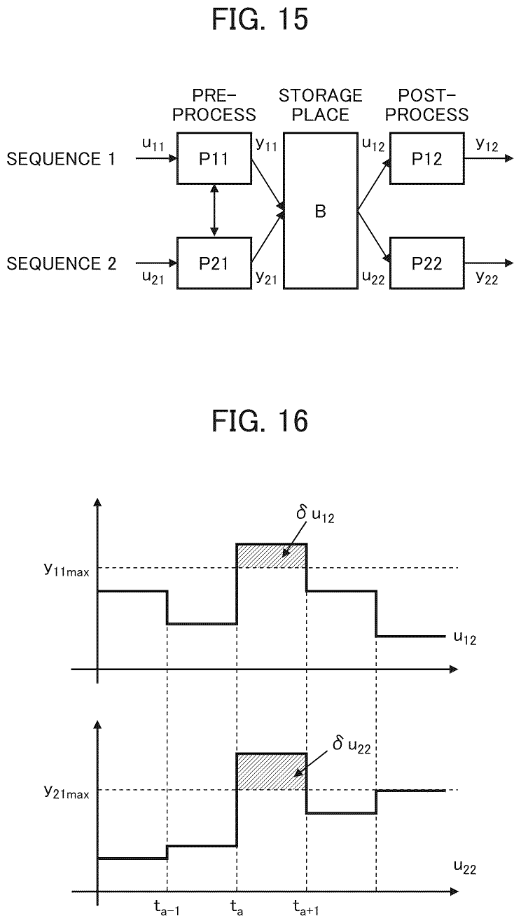

FIG. 15 and FIG. 16 are views illustrating an example where two sequences share the storage place. Hereinafter, as illustrated in FIG. 15, the specific processing content is described by taking a case where two sequences share one storage place B as an example. Also in this embodiment, the system can be expanded such that a plurality of (N pieces of) sequences are arranged in parallel as illustrated in FIG. 12.

Also, in the configuration illustrated in FIG. 15, the basic processing content is same as the content of the embodiment described above. However, in this embodiment, the storage place is shared and hence, it is possible to avoid a situation where continuation in step S113 in FIG. 14 becomes impossible.

In FIG. 16, from a point of time tₐ to a point of time tₐ₊₁, a control input u₁₂ of the post-process P12 exceeds a rated output y₁₁ₘₐₓ in the pre-process P11. The excess amount is δu₁₂. From the point of time tₐ to the point of time tₐ₊₁, a control input u₂₂ of the post-process P22 exceeds a rated output y₂₁ₘₐₓ of the pre-process P21. The excess amount is δu₂₂. Assuming a case where a storage amount at a storage place B does not change, at the point of time tₐ, an output of the post-process P12 and an output of the post-process P22 are below an expected standard. This is because that inputs from the pre-process P11 and the pre-process P21 become insufficient.

Accordingly, in a case where the pre-process ability management unit 603 determines that there exists a point of time tₐ at which the post-process input uᵢ₂ obtained by sequentially calculating from the target value rᵢ exceeds the maximum outputs yᵢ₁ₘₐₓ of the respective pre-processes, the inter process surplus management unit 607 calculates a sum of exceeding weights (δu₁₂+δu₂₂), and the sum is prepared at the storage place B by a previous point of time tₐ₋₁. This can be easily realized by applying the above-mentioned sum of the exceeding amounts to δu₂ in the formula 3 relating to the optimization arithmetic operation of the pre-processes.

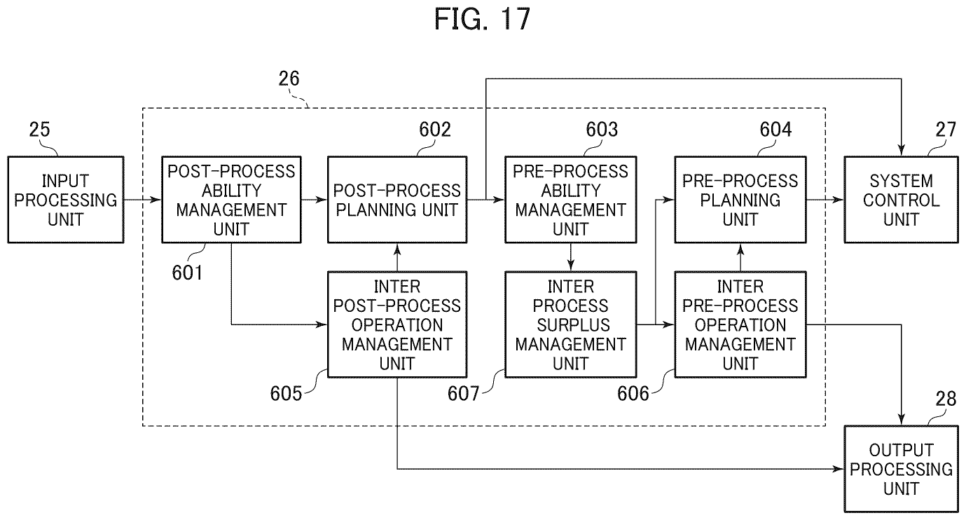

FIG. 17 is a block diagram illustrating the detail of the processing performed by the calculation unit 26 to which the inter process surplus management unit 607 is added. The calculation unit 26 has the functions described above, the inter process surplus management unit 607 is added to a functional block illustrated in FIG. 13.

In a case where the pre-process ability management unit 603 determines that the ability of the pre-process is insufficient (δu₁₂ and δu₂₂ in FIG. 16), the inter process surplus management unit 607 corrects a plan scheduled to be performed in the pre-process. In a case where a surplus is generated in a specified sequence, the inter pre-process operation management unit 606 compensates for shortage of ability by adjusting abilities of the respective pre-processes. In a case where the shortage of ability cannot be compensated even such an adjustment is performed, the inter process surplus management unit 607 changes a plan that the pre-process planning unit 604 is requested to perform such that predicted shortage amounts δu₁₂ and δu₂₂ can be preserved in the storage place in advance.

In a case where a shared storage place is used, it is not necessary that the number of the pre-processes and the number of the post-processes agree with each other. For example, in a case where there are two post-processes and three pre-processes, it is sufficient that the inter process surplus management unit 607 adjusts a storage amount such that a sum value (U₁₂+U₂₂) of the inputs of the post-processes satisfy a sum value (Y₁₁+Y₂₁+Y₃₁) of the output of the pre-processes.

That is, the inter process surplus management unit 607 calculates the storage amount at the storage place in a case where the pre-process ability management unit 603 determines that a maximum output of the pre-processes in the specified sequence is not equal to or more than an input that the post-process planning unit 602 has planned, or ability of the pre-processes in the specified sequence that deals with a time-series change of the output is not equal to or more than a time-series change that the post-process planning unit 602 has planned, and an input required for the post-processes cannot be planned even when at least a portion of the ability of the pre-processes in another sequence where ability is in surplus is provided to the pre-process in the specified sequence where ability is insufficient.

In such a situation, in a case where the pre-process ability management unit 603 determines that a maximum output of the pre-processes in the specified sequence is not equal to or more than an input that the post-process planning unit 602 has planned or ability of the pre-processes that deals with a time-series change of the output in the specified sequence is not equal to or more than a time-series change of an input that the post-process planning unit 602 has planned by taking a storage amount calculated by the inter process surplus management unit 607 into consideration, the inter pre-process operation management unit 606 decides to provide at least a portion of ability of the pre-processes in another sequence to the pre-processes in the specified sequence.

Further, the pre-process planning unit 604, in the pre-process after the decision by the inter pre-process operation management unit 606 is made, calculates an input required for the pre-processes corresponding to a target value that is obtained by adding a storage amount calculated by the inter process surplus management unit 607 to an input that the post-process planning unit 602 planned.

### Advantageous Effects of Embodiments

According to the first and second embodiments, abilities that the respective processes are required to satisfy in the midst of a change of a situation are dynamically calculated, and a surplus between the processes can be minimized. For example, between the processes that are linked in series, the inventory of intermediate products can be minimized. Further, between the processes arranged in parallel, by allowing the processes to share operation ability (materials, parts and the like), the asset-light can be realized.

The present disclosure is not limited to the embodiments described above, and includes various modifications. For example, the above-mentioned embodiments are described in detail to facilitate the understanding of the present disclosure, and it is not always the case that the present disclosure is limited to the configuration that includes all constitutional elements described above. Some constitutional elements of one embodiment may be exchanged with the constitutional elements of the other embodiment and, further, it is also possible to add the constitutional elements of other embodiment to the constitutional elements of one embodiment. With respect to some constitutional elements of the respective embodiments, such constitutional elements can be added, deleted or replaced.

With respect to the respective constitutional elements, functions, processing units, processing means and the like described above, some or the entirety of them may be realized by hardware such as designing using an integrated circuit, for example. The respective constitutional elements, the functions and the like described above may be realized by software by allowing a processor to interpret a program that realizes the respective functions and to execute the program. Information such as programs, tables and files that realize the respective functions may be stored in a recording device such as a memory, a hard disc, a solid state drive (SSD) or a recording medium such as an IC card, an SD card, a DVD or the like.

Control lines and information lines that are considered necessary to describe the disclosure are illustrated, and it is not always the case that all control lines and information lines necessary for a product are illustrated. It is safe to say that almost all constitutional elements are connected with each other in an actual management device.

1. A management device comprising:
a specifying unit that specifies a storage place necessary for storage between processes out of a series of processes leading to shipping of a product;
a dividing unit that divides the series of processes into a plurality of small processes based on the specified storage place;
a setting unit that sets the small process behind the storage place in time series as a post-process and sets the small process ahead of the storage place in time series as a pre-process among the divided small processes;
an input processing unit that receives a shipping plan including a target value of a shipping amount and a shipping time of the product;
a calculation unit that
calculates an input and an output required for the post-process based on dealing ability of the post-process, dealing ability of the pre-process and the shipping plan and, thereafter, calculates an input and an output required for the pre-process, and
calculates a storage amount in the storage place disposed between the post-process and the pre-process based on the calculated input required for the post-process and the calculated output required for the pre-process; and
an output processing unit that outputs a result calculated by the calculation unit.

2. The management device according to claim 1, wherein the calculation unit includes:
a post-process ability management unit that determines whether or not a maximum output of the post-process is equal to or more than the target value, and determines whether or not ability of the post-process that deals with a time-series change of an output is equal to or more than a time-series change of the target value;
a post-process planning unit that plans the input required for the post-process in accordance with the shipping plan;
a pre-process ability management unit that determines whether or not a maximum output of the pre-process is equal to or more than the input that the post-process planning unit has planned, and determines whether or not ability of the pre-process that deals with a time-series change of the output is equal to or more than a time-series change of the input that the post-process planning unit has planned; and
a pre-process planning unit that plans the input required for the pre-process corresponding to the input that the post-process planning unit has planned.

3. The management device according to claim 2, wherein
the post-process planning unit plans a point of time of the input that the post-process planning unit has planned, and
the pre-process planning unit plans a point of time of the input that the pre-process planning unit has planned.

4. The management device according to claim 2, wherein,
in a case where the pre-process ability management unit determines that the maximum output of the pre-process is not equal to or more than the input that the post-process planning unit has planned or the ability of the pre-process that deals with the time-series change of the output is not equal to or more than the time-series change of the input that the post-process planning unit has planned,
the output processing unit notifies the occurrence of the change in the storage amount in the storage place.

5. The management device according to claim 2, wherein,
in a case where the pre-process and the post-process are included in a plurality of parallel sequences,
the calculation unit includes:
the post-process ability management unit that determines whether or not the maximum output of the post-process is equal to or more than the target value, and also determines whether or not the ability of the post-process that deals with the time-series change of the output is equal to or more than the time-series change of the target value;
an inter post-process operation management unit that decides to provide at least a portion of the ability of the post-process in a sequence other than a specified sequence to the post-process in the specified sequence in a case where the post-process ability management unit determines that the maximum output of the post-process in the specified sequence is not equal to or more than the target value or the ability of the post-process that deals with the time-series change of the output in the specified sequence is not equal to or more than the time-series change of the target value;
the post-process planning unit that plans the input required for the post-process in accordance with the shipping plan in the post-process after the decision is made by the inter post-process operation management unit:
the pre-process ability management unit that determines whether or not the maximum output of the pre-process is equal to or more than the input that the post-process planning unit has planned, and also determines whether or not the ability of the pre-process that deals with the time-series change of the output is equal to or more than the time-series change of the input that the post-process planning unit has planned;
an inter pre-process operation management unit that decides to provide at least a portion of the ability of the pre-process in a sequence other than a specified sequence to the pre-process in the specified sequence in a case where the pre-process ability management unit determines that the maximum output of the pre-process in the specified sequence is not equal to or more than the input that the post-process planning unit has planned, or the ability of the pre-process in the specified sequence that deals with a time-series change of the output is not equal to or more than a time-series change of the input that the post-process planning unit has planned; and
the pre-process planning unit that plans the input required for the pre-process in accordance with the input that the post-process planning unit has planned, in the pre-process after the decision is made by the inter pre-process operation management unit.

6. The management device according to claim 2, wherein,
in a case where the pre-process and the post-process are included in a plurality of parallel sequences,
the calculation unit includes:
the post-process ability management unit that determines whether or not the maximum output of the post-process is equal to or more than the target value, and also determines whether or not the ability of the post-process that deals with the time-series change of the output is equal to or more than the time-series change of the target value;
an inter post-process operation management unit that decides to provide at least a portion of the ability of the post-process in a sequence other than a specified sequence to the post-process in the specified sequence in the case where the post-process ability management unit determines that the maximum output of the post-prosses in the specified sequence is not equal to or more than the target value or the ability of the post-process that deals with the time-series change of the output in the specified sequence is not equal to or more than the time-series change of the target value;
the post-process planning unit that plans the input required for the post-process in accordance with the shipping plan in the post-process after the decision is made by the inter post-process operation management unit;
the pre-process ability management unit that determines whether or not the maximum output of the pre-process is equal to or more than the input that the post-process planning unit has planned, and also determines whether or not the ability of the pre-process that deals with the time-series change of the output is equal to or more than the time-series change of the input that the post-process planning unit has planned;
an inter process surplus management unit that calculates the storage amount in the storage place in a case where the pre-process ability management unit determines that the maximum output in the pre-process in the specified sequence is not equal to or more than the input that the post-process planning unit has planned or the ability of the pre-process in the specified sequence that deals with the time-series change of the output is not equal to or more than a time-series change of the input that the post-process planning unit has planned, and even when at least a part of the ability of the pre-process in another sequence is provided to the pre-process in the specified sequence, an input required for the post-process cannot be planned;
the inter pre-process operation management unit that decides to provide at least the portion of the ability of the pre-process in another sequence to the pre-process in the specified sequence in the case where, by taking the storage amount calculated by the inter process surplus management unit into consideration, the pre-process ability management unit determines that the maximum output of the pre-process in the specified sequence is not equal to or more than the input that the post-process planning unit has planned, or the ability of the pre-process in the specified sequence that deals with the time-series change of the output is not equal to or more than the time-series change of the input that the post-process planning unit has planned; and
the pre-process planning unit that, in the pre-process after the decision is made by the inter pre-process operation management unit, calculates the input required for the pre-process corresponding to the target value obtained by adding the storage amount calculated by the inter process surplus management unit to the input that the post-process planning unit has planned.

7. The management device according to claim 1, wherein,
the calculation unit calculates inputs required for the post-process and the pre-process in accordance with a model prediction control, using dynamics and restriction conditions of the pre-process and the post-process set by the setting unit, and using only a plan from a current time to a predetermined future point of time out of the shipping plan that the input processing unit has received.

8. A management system that includes a management device and a management target system managed by the management device, wherein
the management device comprises:
a specifying unit that specifies a storage place necessary for storage between processes out of a series of processes leading to shipping of a product;
a dividing unit that divides the series of processes into a plurality of small processes based on the specified storage place:
a setting unit that sets the small process behind the storage place in time series as a post-process and sets the small process ahead of the storage place in time series as a pre-process among the divided small process;
an input processing unit that receives a shipping plan including a target value of a shipping amount and a shipping time of the product;
a calculation unit that
calculates an input required for the post-process based on dealing ability of the post-process, dealing ability of the pre-process and the shipping plan and, thereafter, calculates an input required for the pre-process, and
calculates a storage amount in the storage place disposed between the post-process and the pre-process, based on the calculated input required for post-process and the calculated input required for the pre-process, and
a system control unit that outputs a result calculated by the calculation unit to the management target system.

9. A management method comprising:
making a specifying unit of a management device specify a storage place necessary for storage between processes out of a series of processes leading to shipping of a product;
making a dividing unit of the management device divide the series of processes into a plurality of small processes based on the specified storage place:
making a setting unit of the management device set the small process behind the storage place in time series as a post-process and set the small process ahead of the storage place in time series as a pre-process among the divided small processes;
making an input processing unit of the management device receive a shipping plan including a target value of a shipping amount and a shipping time of the product;
making a calculation unit of the management device
calculate an input required for the post-process based on dealing ability of the post-process, dealing ability of the pre-process and the shipping plan and, thereafter, calculate an input required for the pre-process and
calculate the storage amount in the storage place disposed between the post-process and the pre-process based on the calculated input required for the post-process and the calculated input required for the pre-process; and
making an output processing unit of the management device output a result calculated by the calculation unit.
